(19) United States
(12) Patent Application Publication
(10) Pub. No.: US 2017/0229779 A1
(43) Pub. Date: Aug. 10, 2017

(54) Antenna Apparatus and Terminal

(71) Applicant: Huawei Technologies Co., Ltd., Shenzhen (CN)

(72) Inventors: Yuanpeng Li, Beijing (CN); Yafang Yu, Beijing (CN); Hanyang Wang, Reading (GB); Jianming Li, Shanghai (CN); Meng Hou, Shanghai (CN); Bo Meng, Shenzhen (CN)

(73) Assignee: Huawei Technologies Co., Ltd., Shenzhen (CN)

(21) Appl. No.: 15/502,355

(22) PCT Filed: Aug. 8, 2014
(86) PCT No.: PCT/CN2014/084019

§ 371 Date: Feb. 7, 2017

(51) Int. Cl. H01Q 9/04; H01Q 1/48; H01Q 3/24; H01Q 5/30; H01Q 1/38; H01Q 7/00

(52) U.S. Cl. CPC H01Q 9/04; H01Q 1/38; H01Q 7/00; H01Q 3/24; H01Q 5/30; H01Q 1/48

(57) ABSTRACT

An antenna apparatus includes: one antenna body, a first filter apparatus, and a second filter apparatus; where the first filter apparatus includes a first inductor and a first high-pass low-impedance component, and the second filter apparatus includes a second inductor and a second high-pass low-impedance component; a feed connector is disposed on the first filter apparatus, and a ground connector is disposed on the second filter apparatus; the first inductor and the first high-pass low-impedance component are both electrically connected in parallel between a first end of the antenna body and the feed connector; and the second inductor and the second high-pass low-impedance component are both electrically connected in parallel between a second end of the antenna body and the ground connector.

### CROSS-REFERENCE TO RELATED APPLICATIONS

This application is a national stage application of international patent application number PCT/CN2014/084019 filed on Aug. 8, 2014, which is incorporated by reference.

### TECHNICAL FIELD

The present disclosure relates to communications technologies, and in particular, to an antenna apparatus and a terminal.

### BACKGROUND

Along with rapid development of the terminal industry, compared with the era of previous feature phones, people pay more attention to an appearance and a shape of a terminal, and the terminal as a whole is also developing towards a trend of ultra-thin and ultra-light, which imposes a higher requirement on a terminal antenna product.

Generally, a conventional antenna solution is to use an inverted F antenna (IFA) as a terminal antenna, and another conventional solution is to use a loop antenna as a terminal antenna.

However, because an actual length of the terminal antenna needs to be correlated with a wavelength corresponding to an operating frequency of the terminal antenna, for example, when the terminal antenna operates at a low frequency, its resonance needs to be a quarter of the wavelength corresponding to the operating frequency. However, because the low frequency has a relatively long wavelength, regardless of whether the terminal antenna is an IFA antenna or a loop antenna, the terminal antenna occupies relatively large space.

### SUMMARY

Embodiments of the present disclosure provide an antenna apparatus and a terminal, so as to resolve a technical problem in some approaches that a terminal antenna occupies large space.

According to a first aspect of the embodiments of the present disclosure, an antenna apparatus is provided, including: an antenna body, a first filter apparatus, and a second filter apparatus; where the first filter apparatus includes a first inductor and a first high-pass low-impedance component, and the second filter apparatus includes a second inductor and a second high-pass low-impedance component; a feed connector is disposed on the first filter apparatus, and a ground connector is disposed on the second filter apparatus; and the first inductor and the first high-pass low-impedance component are both electrically connected in parallel between a first end of the antenna body and the feed connector; and the second inductor and the second high-pass low-impedance component are both electrically connected in parallel between a second end of the antenna body and the ground connector.

According to the first aspect, in a first possible implementation manner, the antenna apparatus operates in a first frequency band, a second frequency band, and a third frequency band, the first frequency band includes a first frequency and a second frequency, the second frequency band includes a third frequency and a fourth frequency, the third frequency band includes a fifth frequency and a sixth frequency, the antenna apparatus is inductive at all the first frequency, the third frequency, and the fifth frequency, and capacitive at all the second frequency, the fourth frequency, and the sixth frequency.

With reference to the first aspect and the first possible implementation manner, in a second possible implementation manner, the antenna body is a loop antenna.

With reference to the first aspect, the first possible implementation manner, and the second possible implementation manner, in a third possible implementation manner, the first high-pass low-impedance component is a switch.

With reference to the first aspect, the first possible implementation manner, the second possible implementation manner, and the third possible implementation manner, in a fourth possible implementation manner, the second high-pass low-impedance component is a switch.

With reference to the first aspect, the first possible implementation manner, the second possible implementation manner, and the fourth possible implementation manner, in a fifth possible implementation manner, the first high-pass low-impedance component is a capacitor or a microstrip; and values of the first inductor and the first high-pass low-impedance component are determined according to an operating frequency of the antenna body.

With reference to the first aspect, the first possible implementation manner, the second possible implementation manner, the third possible implementation manner, and the fifth possible implementation manner, in a sixth possible implementation manner, the second high-pass low-impedance component is a capacitor or a microstrip; and values of the second inductor and the second high-pass low-impedance component are determined according to an operating frequency of the antenna body.

According to a second aspect of the embodiments in the present disclosure, a terminal is provided, including: a printed circuit board and the antenna apparatus according to any one of the possible implementation manners of the first aspect, where a feeder apparatus and a ground end are disposed on the printed circuit board, the feed connector and the feeder apparatus are connected, and the ground connector and the ground end are electrically connected.

The antenna apparatus provided in the embodiments of the present disclosure includes: an antenna body, a first filter apparatus, and a second filter apparatus; where the first filter apparatus includes a first inductor and a first high-pass low-impedance component, and the second filter apparatus includes a second inductor and a second high-pass low-impedance component; a feed connector is disposed on the first filter apparatus, and a ground connector is disposed on the second filter apparatus; the first inductor and the first high-pass low-impedance component are both electrically connected in parallel between a first end of the antenna body and the feed connector; and the second inductor and the second high-pass low-impedance component are both electrically connected in parallel between a second end of the antenna body and the ground connector. With the technical solutions provided in the embodiments of the present disclosure, due to low-pass and high-impedance characteristics of an inductor, the first inductor and the second inductor can effectively excite a low frequency electromagnetic wave. Therefore, using an antenna body in a short length can achieve a low frequency resonance, thereby reducing space occupied by an antenna of a terminal while ensuring antenna performance.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a schematic structural diagram of an antenna apparatus according to

Embodiment 1 of the present disclosure;

FIG. 2a is a schematic structural diagram of an antenna apparatus according to Embodiment 2 of the present disclosure;

FIG. 2b is a schematic structural diagram of another antenna apparatus according to Embodiment 2 of the present disclosure;

FIG. 3a is a schematic diagram of radiation efficiency of an antenna apparatus according to Embodiment 2 of the present disclosure;

FIG. 3b is a Smith circular diagram of an antenna apparatus according to Embodiment 2 of the present disclosure; and

FIG. 4 is a schematic structural diagram of a terminal according to Embodiment 3 of the present disclosure.

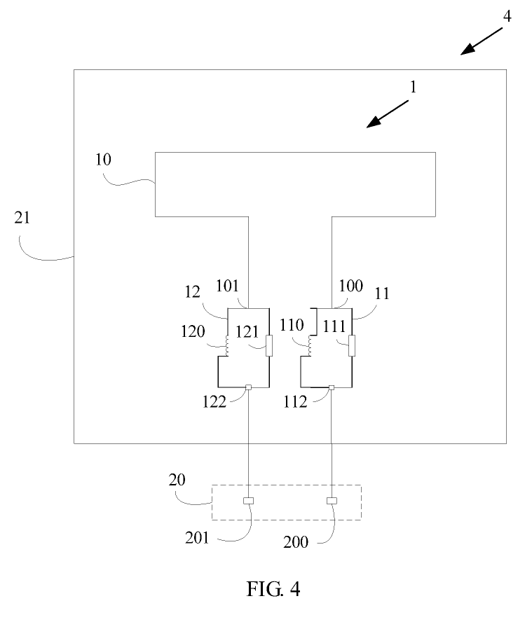

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

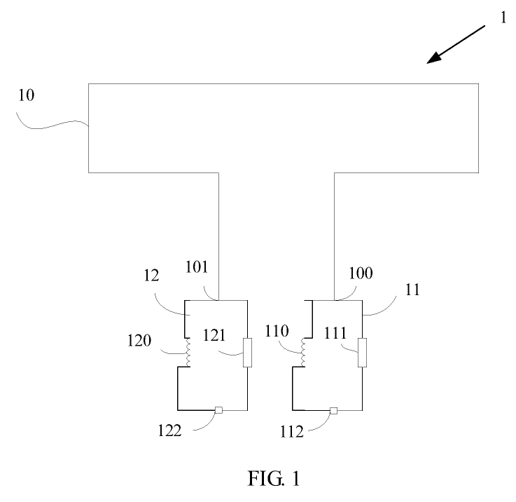

FIG. 1 is a schematic structural diagram of an antenna apparatus 1 according to Embodiment 1 of the present disclosure. As shown in FIG. 1, the antenna apparatus 1 includes: an antenna body 10, a first filter apparatus 11, and a second filter apparatus 12.

Specifically, the first filter apparatus 11 includes a first inductor 110 and a first high-pass low-impedance component 111, and the second filter apparatus 12 includes a second inductor 120 and a second high-pass low-impedance component 121.

A feed connector 112 is disposed on the first filter apparatus 11, and a ground connector 122 is disposed on the second filter apparatus 12. The first conductor 110 and the first high-pass low-impedance component 111 are both electrically connected in parallel between a first end 100 of the antenna body 10 and the feed connector 112; and the second inductor 120 and the second high-pass low-impedance component 121 are both electrically connected in parallel between a second end 101 of the antenna body 10 and the ground connector 122.

In addition, the feed connector 112 is configured to connect to a feed end or feed of a feeder apparatus, the feeder apparatus is configured to provide an input signal for the antenna apparatus 1, and the ground connector 122 is configured to connect to a ground end or ground of a terminal on which the antenna apparatus 1 is located.

It can be learned according to an electrical principle that an inductor has low-pass and high-impedance characteristics. Therefore, in an actual application, the first inductor 110 and the second inductor 120 operate at a low frequency, which effectively excites a low frequency electromagnetic wave. This is equivalent to sharing a part of a length of the antenna body 10, that is, a length of an actual cable of the antenna body 10. In this way, compared with an IFA antenna or a loop antenna in some approaches, the antenna apparatus 1 may achieve a low frequency resonance with a shorter actual length, for example, requiring only one-eighth or even shorter of a wavelength corresponding to the low frequency electromagnetic wave. For example, to achieve same low frequency antenna radiation performance as that in some approaches, actual dimensions (depth (D)×width (W)×height (h)) of a loop antenna in those approaches are 65 millimeters (mm)×10 mm×3 mm. However, if the antenna apparatus in the present application is used, and if the antenna body 10 is a loop antenna, actual dimensions (D×W×H) of the antenna body 10 used by the antenna apparatus need only to be 15 mm×10 mm×3 mm. The first high-pass low-impedance component 111 and the second high-pass low-impedance component 121 operate at a high frequency. Because a high frequency electromagnetic wave corresponds to a relatively short wavelength, the relatively short antenna body 10 can meet a requirement for a high frequency resonance, thereby achieving relatively good high frequency antenna radiation performance.

It should be noted that the first high-pass low-impedance component 111 and the second high-pass low-impedance component 121 are not specifically limited herein to which type of electronic component, provided that they have high-pass and low-impedance characteristics. In addition, specific values of the first inductor 110, the second inductor 120, the first high-pass low-impedance component 111, and the second high-pass low-impedance component 121 may be set according to an actual operating frequency of the antenna apparatus 1.

The antenna apparatus provided in this embodiment of the present disclosure includes: an antenna body, a first filter apparatus, and a second filter apparatus; where the first filter apparatus includes a first inductor and a first high-pass low-impedance component, and the second filter apparatus includes a second inductor and a second high-pass low-impedance component; a feed connector is disposed on the first filter apparatus, and a ground connector is disposed on the second filter apparatus; the first inductor and the first high-pass low-impedance component are both electrically connected in parallel between a first end of the antenna body and the feed connector; and the second inductor and the second high-pass low-impedance component are both electrically connected in parallel between a second end of the antenna body and the ground connector. Using the technical solution provided in this embodiment of the present disclosure may reduce space occupied by an antenna of a terminal while ensuring antenna performance.

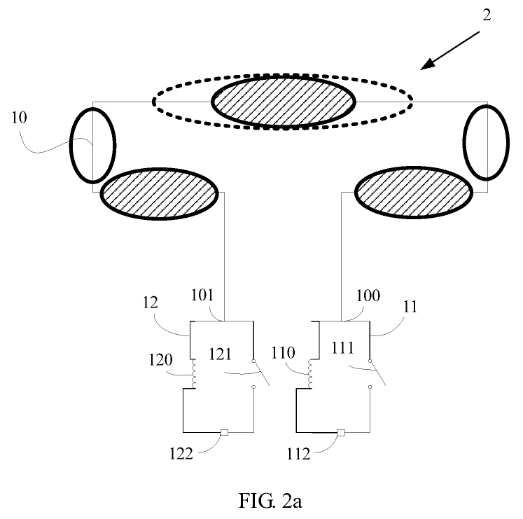

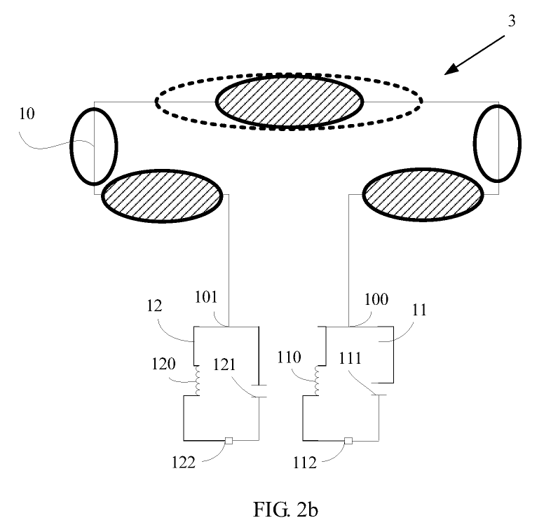

FIG. 2a is a schematic structural diagram of an antenna apparatus 2 according to Embodiment 2 of the present disclosure. As shown in FIG. 2a, the antenna apparatus 2 includes: an antenna body 10, a first filter apparatus 11, and a second filter apparatus 12.

Specifically, the antenna body 10 may be a loop antenna, that is, a loop antenna. It should be noted that the loop antenna herein may be in a symmetric structure, or may be in an asymmetric structure. In addition, in practice, an asymmetric form of the loop antenna may be adjusted to enable the antenna apparatus 2 to generate more high frequency resonances, thereby supporting more high frequency modes. The following shows a diagram and description about the symmetric structure only, but the loop antenna in the asymmetric structure also falls within the protection scope of the present disclosure.

A first high-pass low-impedance component 111 and a second high-pass low-impedance component 121 may both be switches.

Optionally, the first high-pass low-impedance component 111 and the second high-pass low-impedance component 121 may be implemented by using another electronic component. FIG. 2b is a schematic structural diagram of another antenna apparatus according to Embodiment 2 of the present disclosure. Compared with FIG. 2a, a difference in the FIG. 2b is that the first high-pass low-impedance component 111 and the second high-pass low-impedance component 121 in an antenna apparatus 3 shown in FIG. 2b are both capacitors. In practice, both of the foregoing capacitors may be implemented by using a variable capacitor, a distributed capacitor, a centralized capacitor, or the like.

Optionally, because a microstrip can implement a capacitor function, the microstrip may take the place of the capacitor as the high-pass low-impedance component, and details are not shown in diagrams or described herein again.

Using FIG. 2b as an example and with reference to an actual application, the following separately describes an operating principle and a corresponding setting of the antenna apparatus 3. An operating principle and a setting of the antenna apparatus 2 are similar to those of the antenna apparatus 3, and details are not described herein again.

Specifically, during operation, just like the description in Embodiment 1, in the antenna apparatus 3, symmetric two groups of filter apparatuses are added to a feeder part of a loop antenna in a symmetric structure in the present disclosure. Because a filter apparatus includes a capacitor and an inductor in parallel, when the antenna apparatus 3 operates at a low frequency, a current from feeding point to ground passes through a path of a first inductor 110 and a second inductor 120, so as to make use of its low-pass and high-impedance characteristics to achieve low frequency radiation; and when the antenna apparatus 3 operates at a high frequency, the current from feeding point to ground passes through a path of capacitors that are separately connected to the first inductor 110 and the second inductor 120 in parallel, so as to make use of its high-pass and low-impedance characteristics to achieve high frequency radiation. In this way, one low frequency resonance may be formed in a low frequency mode, and two high frequency resonances may be formed in a high frequency mode.

Optionally, during operation, a specific value of an electronic component may be configured, that is, values of the first inductor 110 and the first high-pass low-impedance component 111 may be determined according to an operating frequency of the antenna body 10, or values of the second inductor 120 and the second high-pass low-impedance component 121 may be determined according to an operating frequency of the antenna body 10, so that the antenna apparatus 3 operates in a preset frequency band.

Specifically, the antenna apparatus 3 may operate in a first frequency band, a second frequency band, and a third frequency band, the first frequency band includes a first frequency and a second frequency, the second frequency band includes a third frequency and a fourth frequency, the third frequency band includes a fifth frequency and a sixth frequency, the antenna apparatus is inductive at all the first frequency, the third frequency, and the fifth frequency, and capacitive at all the second frequency, the fourth frequency, and the sixth frequency.

An operating frequency band of a Long-Term Evolution (LTE) terminal, that is, generally three frequency bands, a low frequency from 824 megahertz (MHz) to 960 MHz and high frequencies from 1710 MHz to 2170 MHz and from 2520 MHz to 2690 MHz, need to be covered, is used as an example. When the antenna apparatus in the present application, for example, the antenna apparatus 3, is applied, a length of the antenna body 10 of the antenna apparatus 3 may be set, a specific value of an electronic component of the antenna apparatus may be selected, and so on, to enable the antenna apparatus to operate in a first frequency band from 824 MHz to 960 MHz, a second frequency band from 1710 MHz to 2170 MHz, and a third frequency band from 2520 MHz to 2690 MHz. A specific setting method is: because a center frequency corresponding to the foregoing low frequency band is approximately 900 MHz, a center frequency corresponding to a high frequency band is approximately 1800 MHz, and the first filter apparatus 11 and the second filter apparatus 12 of the antenna apparatus 3 actually form a stopband filter, a frequency of a stopband part of the stopband filter simply needs to be set between 900 MHz and 1800 MHz, on a purpose that an actually required frequency band, that is, the foregoing frequency band range, can pass through the stopband filter. A specific setting of a capacitance value or an inductance value of the stopband filter is the same as that in some approaches of this field and details are not described herein again.

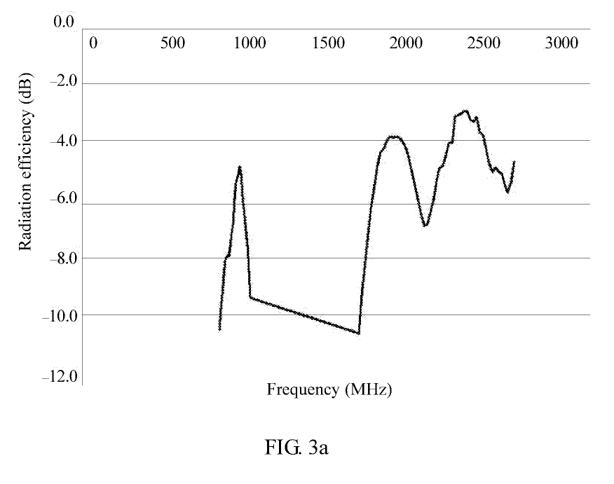

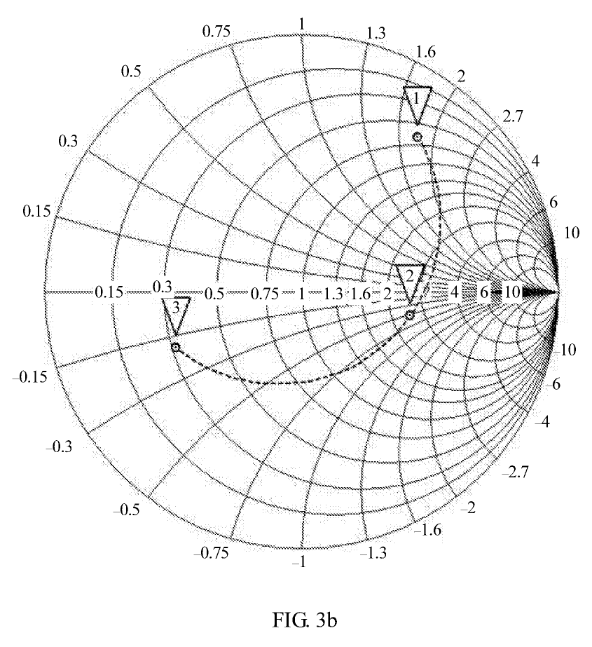

Correspondingly, the first frequency at which the antenna apparatus 3 operates is 824 MHz, the second frequency is 960 MHz, the third frequency is 1710 MHz, the fourth frequency is 2170 MHz, the fifth frequency is 2520 MHz, and the sixth frequency is 2690 MHz. Actual performance of the antenna apparatus 3, that is, radiation efficiency of the antenna apparatus 3, is shown in FIG. 3a, where the horizontal axis represents an operating frequency of the antenna apparatus 3 in unit of MHz, and the vertical axis represents the radiation efficiency of the antenna apparatus 3 in unit of decibel (dB). It can be seen from FIG. 3a that the antenna apparatus 3 can cover one low frequency band and two high frequency bands, thereby meeting an antenna coverage requirement of an LTE terminal. FIG. 3b is a Smith circular diagram of an antenna apparatus according to Embodiment 2 of the present disclosure. As shown in FIG. 3b, digits marked using inverted triangular boxes represent different operating frequencies of an antenna apparatus 3, where a digit 1 represents 824 MHz, a digit 2 represents 880 MHz, and a digit 3 represents 960 MHz. Because the antenna apparatus 3 generates a resonance in all the three frequency bands, according to an antenna principle, a resonance number means that input impedance of the antenna apparatus is a real number, that is, an imaginary part of the input impedance is zero. Zero input impedance corresponds to a real number axis in FIG. 3b, that is, a horizontal straight line marked with a real digit, and two sides of the real number axis respectively represent an inductive reactance and a capacitive reactance of the antenna apparatus 3. Specifically, if the imaginary part of the input impedance is greater than 0, that is, when a frequency is located above the real number axis, it indicates that the antenna apparatus 3 is inductive at the frequency; and if the imaginary part of the input impedance is less than 0, that is, when a frequency is located below the real number axis, it indicates that the antenna apparatus 3 is capacitive at the frequency. It can be seen from FIG. 3b that the antenna apparatus 3 is inductive at the first frequency, that is, 824 MHz, and the antenna apparatus 3 is capacitive at the second frequency, that is, 960 MHz. Herein, only a smith diagram in a case in which the antenna apparatus 3 operates in the foregoing first frequency band is provided. Certainly, this analysis process is also applicable to a smith diagram if the antenna apparatus 3 operates in the second frequency band and a smith diagram in a case in which the antenna apparatus 3 operates in the third frequency band. Therefore, it can be concluded that the antenna apparatus 3 is inductive both at the third frequency and the fifth frequency, and capacitive both at the fourth frequency and the sixth frequency, and details are not shown in diagrams or described herein again.

Further, a loop antenna of the antenna apparatus 3 is in a symmetric structure, and an inductor is added to both a feed connector and a ground connector of the loop antenna. Therefore, when the first filter apparatus 11 and the second filter apparatus 12 are in bilateral symmetry, that is, connection manners shown in FIG. 2a and FIG. 2b, and values of the first inductor 110 and the second inductor 120 are equal, in a low frequency mode, that is, the antenna apparatus 3 operates in the first frequency band, that is, 824 MHz to 960 MHz in the foregoing example, a largest electric field area of the antenna apparatus 3 is located in the middle of the loop antenna, that is, dotted borders and hollow filling elliptical areas in FIG. 2a and FIG. 2b, and the low frequency mode can correspond to the first peak radiation efficiency point from the left in FIG. 3a; in a first high frequency mode, that is, the antenna apparatus 3 operates in the second frequency band, that is, a frequency band from 1710 MHz to 2170 MHz in the foregoing example, the largest electric field area of the antenna apparatus 3 is located on two sides of the loop antenna, that is, real line borders and hollow filling elliptical areas in FIG. 2a and FIG. 2b, and the first high frequency mode corresponds to the second peak radiation efficiency point from the left in FIG. 3a; and in a second high frequency mode, that is, the antenna apparatus 3 operates in the third frequency band, that is, a frequency band from 2520 MHz to 2690 MHz in the foregoing example, the largest electric field area of the antenna apparatus 3 is like the real line borders and dashed line filling elliptical areas in FIG. 2a and FIG. 2b, and the second high frequency mode corresponds to the third peak radiation efficiency point from the left in FIG. 3a, and the peak radiation efficiency point herein is a point that is of the antenna apparatus 3 and that has largest energy in a specific frequency band. In this way, the antenna apparatus may be disposed in space with optimal antenna clearance, not only relatively high efficiency and bandwidth can be maintained at the low frequency, but also relatively good high frequency antenna radiation performance can be achieved in the high frequency mode provided that a length of the antenna body 10 is adequate for achieving a high frequency resonance, which is similar to the description in Embodiment 1. It should be noted that the largest electric field area in FIG. 2a and FIG. 2b is just an illustration of a location and its size does not necessarily represent the actual largest electric field area of the antenna apparatus.

Certainly, for FIG. 2a, coverage of the antenna apparatus 3 in a broad frequency band can be achieved simply by controlling a switch, that is, enabling switches that are respectively connected to the first inductor 110 and the second inductor 120 in parallel when the antenna apparatus 3 operates at a low frequency, and disabling the foregoing two switches when the antenna apparatus 3 operates at a high frequency.

Compared with some approaches, for a loop antenna, its performance is relatively balanced and is relatively easy to be made an antenna for a broad frequency band. However, because the loop antenna occupies a relatively large area, in a severe environmental condition, that is, in a case in which antenna clearance available for use is relatively small, application of the loop antenna is restricted. Just like the foregoing description, after the antenna apparatus 2 or the antenna apparatus 3 is used, this type of compact loop antenna uses loop wiring, and when the first filter apparatus 11 and the second filter apparatus 12 are in bilateral symmetry, in this case, because symmetrically matched feeding is used at the feed connector 112 of the first filter apparatus 11 and the ground connector 122 of the second filter apparatus 12, that is, symmetric design is performed on both sides at the same time, electric field intensity of radiation can be ensured to the greatest extent to maintain optimal space. Therefore, similar to the principle described in Embodiment 1, because an actual length of the loop antenna in the antenna apparatus 2 is shorter, the loop antenna can be applicable to some severe environmental conditions while radiation performance of the antenna is ensured.

It should be noted that, in an actual application, the foregoing loop antenna in the symmetric structure may be round or in another shape with a symmetric structure. In FIG. 2a, a square loop antenna is used only as an example, but is not used as a limitation.

In addition, FIG. 2a shows a case in which the first high-pass low-impedance component 111 and the second high-pass low-impedance component 121 are both switches, and FIG. 2b shows a case in which the foregoing two components are both capacitors, but in an actual application, they may be implemented asymmetrically. Specifically, if the first high-pass low-impedance component 111 is configured as a switch but the second high-pass low-impedance component 121 is configured as a capacitor or a microstrip, or the second high-pass low-impedance component 121 is configured as a switch but the first high-pass low-impedance component 111 is configured as a capacitor, a microstrip, or an asymmetric design in another form. A specific operating principle of the two components is similar to that in FIG. 2a and FIG. 2b, and details are not shown in diagrams or described herein again. Alternatively, still according to the connection manner shown in FIG. 2b, values of the first inductor 110 and the second inductor 120 are set to be different, so as to control the largest electric field area at a low frequency to shift, thereby avoiding an area with a poor environment, or avoiding being touched by a human body.

The antenna apparatus provided in this embodiment of the present disclosure includes: an antenna body, a first filter apparatus, and a second filter apparatus; where the first filter apparatus includes a first inductor and a first high-pass low-impedance component, and the second filter apparatus includes a second inductor and a second high-pass low-impedance component; a feed connector is disposed on the first filter apparatus, and a ground connector is disposed on the second filter apparatus; the first inductor and the first high-pass low-impedance component are both electrically connected in parallel between a first end of the antenna body and the feed connector; and the second inductor and the second high-pass low-impedance component are both electrically connected in parallel between a second end of the antenna body and the ground connector. Using the technical solution provided in this embodiment of the present disclosure may reduce space occupied by an antenna of a terminal while ensuring antenna performance.

1.-9. (canceled)

10. An antenna apparatus comprising:
an antenna body comprising a first end and a second end;
a first filter apparatus comprising a first inductor and a first high-pass low-impedance component;
a feed connector disposed on the first filter apparatus, Wherein the first inductor and the first high-pass low-impedance component are electrically connected in parallel between the first end and the feed connector;
a second filter apparatus comprising a second inductor and a second high-pass low-impedance component; and
a ground connector disposed on the second filter apparatus, wherein the second inductor and the second high-pass tow-impedance component are electrically connected in parallel between the second end and the ground connector.

11. The antenna apparatus of claim 10, wherein the antenna apparatus operates in a first frequency band comprising a first frequency and a second frequency, a second frequency hand comprising a third frequency and a fourth frequency, and a third frequency hand comprising a fifth frequency and a sixth frequency, wherein the antenna apparatus is inductive at the first frequency, the third frequency, and the fifth frequency, and wherein the antenna apparatus is capacitive at the second frequency, the fourth frequency, and the sixth frequency.

12. The antenna apparatus of claim 10, wherein the antenna body is a loop antenna.

13. The antenna apparatus of claim 10, wherein the first high-pass low-impedance component includes a switch.

14. The antenna apparatus of claim 10, wherein the second high-pass low-impedance component includes a switch.

15. The antenna apparatus of claim 10, wherein the first high-pass low-impedance component includes a capacitor, and wherein values of the first inductor and the first high-pass low-impedance component are based on an operating frequency of the antenna body.

16. The antenna apparatus of claim 15, wherein the capacitor is a variable capacitor, a distributed capacitor, a microstrip, or a centralized capacitor.

17. The antenna apparatus of claim 10, wherein the second high-pass low-impedance component includes a capacitor, and wherein values of the second inductor and the second high-pass low-impedance component are based on an operating frequency of the antenna body.

18. The antenna apparatus of claim 17, wherein the capacitor is a variable capacitor, a distributed capacitor, a microstrip, or a centralized capacitor.

19. A terminal comprising:
a printed circuit board;
a feeder apparatus disposed on the printed circuit hoard;
a ground end disposed on the printed circuit hoard; and
an antenna apparatus comprising:
an antenna body comprising a first end and a second end;
first filter apparatus comprising a first inductor and a first high-pass low-impedance component;
a feed connector disposed on the first filter apparatus and connected to the feeder apparatus, wherein the first inductor and the first high-pass low-impedance component are electrically connected in parallel between the first end and the feed connector;
a second filter apparatus comprising a second inductor and a second high-pass low-impedance component;
a ground connector disposed on the second filter apparatus and electrically connected to the ground end, wherein the second inductor and the second high-pass lows impedance component are electrically connected in parallel between the second end and the ground connector.

20. The terminal of claim 19, wherein the antenna apparatus operates in a first frequency band comprising a first frequency and a second frequency, a second frequency band comprising a third frequency and a fourth frequency, and a third frequency band comprising a fifth frequency and a sixth frequency, wherein the antenna apparatus is inductive at the first frequency, the third frequency, and the fifth frequency, and wherein the antenna apparatus is capacitive at the second frequency, the fourth frequency, and the sixth frequency.

21. The terminal of claim 19, wherein the antenna body is a loop antenna.

22. The terminal of claim 19, wherein the first high-pass low-impedance component includes a switch.

23. The terminal of claim 19, wherein the second high-pass low-impedance component includes a switch.

24. The terminal of claim 19, wherein the first high-pass low-impedance component includes a capacitor, and wherein values of the first inductor and the first high-pass low-impedance component are based on an operating frequency of the antenna body.

25. The terminal of claim 24, wherein the capacitor is a variable capacitor, a distributed capacitor, a microstrip, or a centralized capacitor.
